(19) United States
(12) Patent Application Publication
(10) Pub. No.: US 2004/0229575 A1
(43) Pub. Date: Nov. 18, 2004

(54) Wireless weight scale

(76) Inventors: Hing Kai Chan, Hong Kong (HK); Dennis Chung Po Wong, Hong Kong (HK)

Correspondence Address: NEAL, GERBER, & EISENBERG, SUITE 2200, 2 NORTH LASALLE STREET, CHICAGO, IL, 60602, US

(21) Appl. No.: 10/439,454

(22) Filed: May 16, 2003

(51) Int. Cl. H04Q 7/20

(52) U.S. Cl. 455/90.3; 455/90.1

(57) ABSTRACT

A wireless weight scale and system. A receiving platform includes a top side and a bottom side. The receiving platform can receive a load having a mass. A load cell is disposed on the bottom side of the receiving platform. The load cell includes a load cell wireless transmitter and often a load cell wireless receiver. A control unit includes a display and a processor connected to a wireless transmitter and a wireless receiver. The load cell wireless transmitter transmits a wireless signal to the wireless receiver of the control unit upon the detection, by the load cell, of the load upon the receiving platform.

### FIELD

The present invention generally relates to weight scales, and more specifically to weight scales having electronics for measuring and transmitting weight information.

### BACKGROUND

A conventional transparent weight scale has a surface with supports located at corners of the surface. The supports have sensors and circuitry to measure weight information from a user or object situated on the scale surface. A display is often provided to communicate with the supports and provide information to a user.

The conventional transparent weight scale has wires which connect the supports to the display to transmit information between the supports and the display. While the wires can be placed along the outer periphery of the surface, physical connections still exist around the scale, and are required between the scale and the display. Because these physical connections are exposed to the ambient environment, the physical connections are susceptible to noise (e.g., from power lines, radio signals) during measurement. It would be desirable to completely remove the wires to have a truly transparent scale.

Another problem with conventional transparent weight scales, in particular the supports, is calibration. Calibrating circuits are needed in the display to individually calibrate the sensors at the supports to offset compensation, span matching and impedance normalization. This additional circuitry incurs time and expense, and occupies space on the device.

### SUMMARY

Aspects of the present invention relate to a wireless weight scale and system. A receiving platform includes a top side and a bottom side. The receiving platform can receive a load having a mass. At least one load cell is disposed on the bottom side of the receiving platform. The load cell includes a load cell wireless transmitter and often a load cell wireless receiver. A control unit includes a display and a processor connected to a wireless transmitter and a wireless receiver. The load cell wireless transmitter transmits a wireless signal to the wireless receiver of the control unit upon the detection, by the load cell, of the load upon the receiving platform.

### BRIEF DESCRIPTION OF THE FIGURES

The invention may be better understood with reference to the following figures. The components in the figures are not necessarily to scale, emphasis instead being placed upon clearly illustrating the principles of the present invention. Moreover, in the figures, like reference numerals designate corresponding parts throughout the several views.

FIG. 1A illustrates a perspective view of a wireless weight scale 10a, made in accordance with a first embodiment of the present invention;

FIG. 1B illustrates a perspective view of a wireless weight scale 10b, made in accordance with a second embodiment of the present invention;

FIG. 2 illustrates a block diagram of the circuitry of the weight scales of FIGS. 1A and 1B;

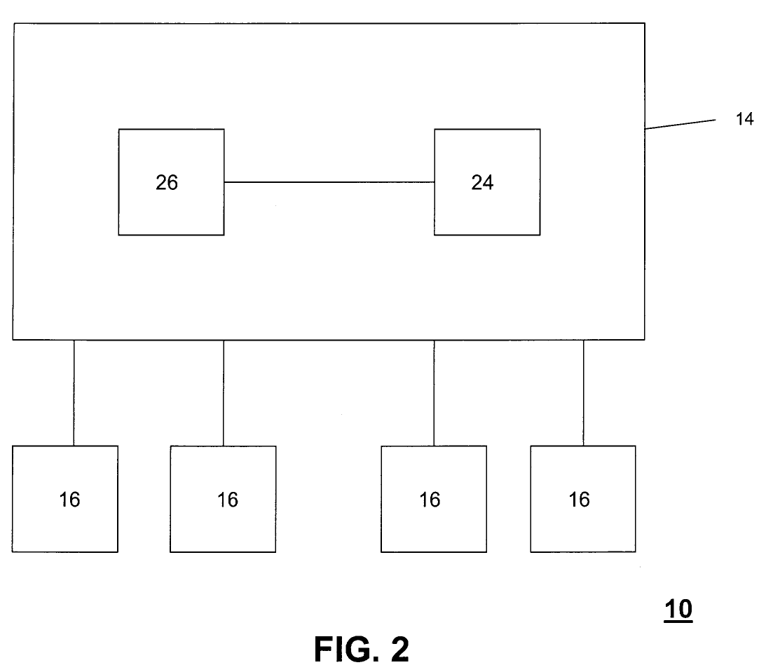

FIG. 3 illustrates a block diagram of a control unit of the weight scales of FIGS. 1A and 1B; and

FIG. 4 illustrates a flow chart of a method for determining the weight of an object, performed in accordance with an embodiment of the present invention.

### DETAILED DESCRIPTION

Embodiments of the present invention are directed towards a wireless weight scale for use in a variety of applications in which the mass or weight, the terms used interchangeably herein, of an object placed thereupon is to be determined, quantified, measured or calculated.

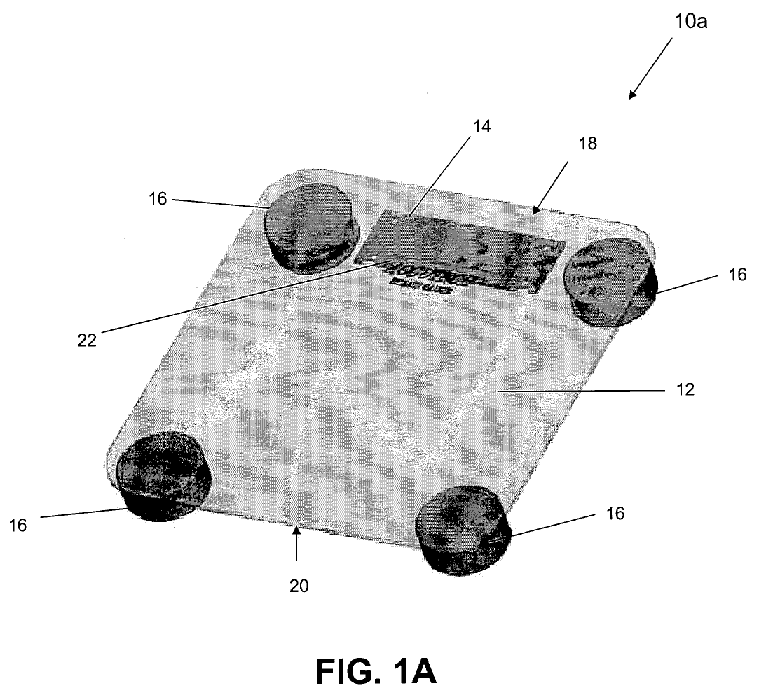

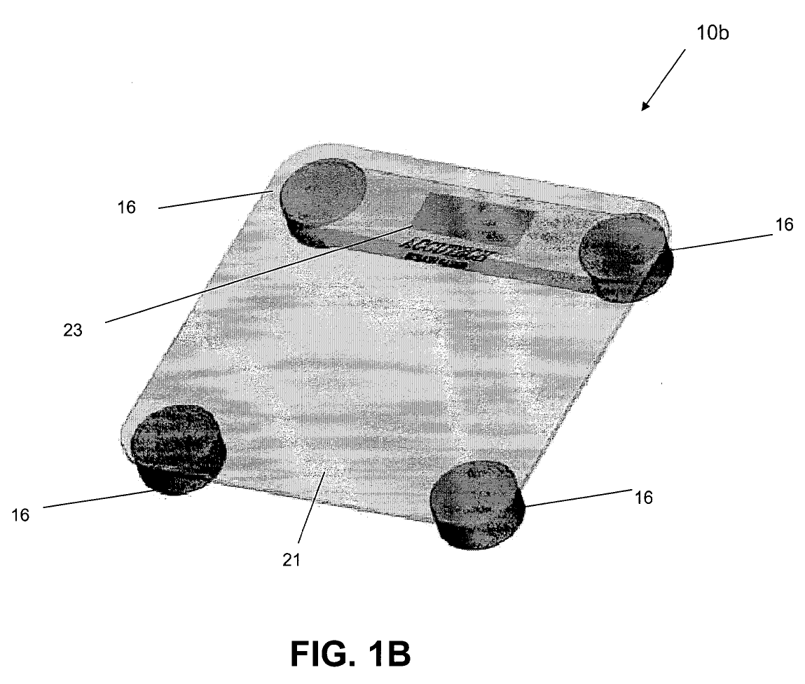

FIG. 1A shows a wireless weight scale 10a constructed in accordance with an embodiment of the present invention. In the embodiment of FIG. 1A, wireless weight scale 10a includes a receiving platform 12, control unit 14, and a plurality of load cells 16. Although four load cells 16 are provided in this embodiment, it is contemplated that alternative embodiments of the wireless weight scale include a single load cell, two load cells as shown in FIG. 1B, or any number of load cells 16.

In FIG. 1A, receiving platform 12 is preferably formed from a transparent, shapeable or moldable, hardened material. Examples of such materials which may be formed into receiving platform 12 are various plastics, resins, tempered glasses, and metals, provided that the materials meet the above-stated preferred characteristics. Generally formed into a substantially square or rectangular shape, receiving platform 12 is preferably used for receiving and holding the object for which weight is to be determined. For example, if wireless weight scale 10a is to function as a personal weight scale, then receiving platform 12 is the place on wireless weight scale 10a on which the user stands to have his weight determined.

In FIG. 1A, receiving platform 12 includes top side 18 and bottom side 20. To facilitate the mass determining aspect of the present invention, it is preferable that the surfaces defining both top side 18 and bottom side 20 of receiving platform 12 are substantially flat and in substantial parallel alignment with each other. In this way, the mass determination capabilities of the present invention are most effective.

In FIG. 1A, control unit 14 is illustrated as being disposed near one end of receiving platform 12. For purposes of discussion, this end will be referred to as front end 22 of receiving platform 12. In another embodiment, shown in FIG. 1B, a control unit 23 occupies substantially all of front end 22 of receiving platform 12. The control unit 23 can be connected directly to one or more load cells 16 at the front end 22 of receiving platform 12. In the embodiment of FIG. 1B, the wireless weight scale 10b includes two load cells 16 situated at a rear end 21 opposite front end 22 of receiving platform 12. In yet another embodiment, the control unit is remotely located from receiving platform 12. Control unit 14, including display 24, may be mounted or otherwise positioned on a wall, a table or observation platform, separate from weight scale 10a or 10b. Control unit 14 may also be connected to a workstation, desktop computer, portable computer, PDA or other computational device for analysis and manipulation of weight readings, information or data. In another embodiment, the control unit is portable, that is, can be moved to various locations. Some locations to which control unit 14 can be transported, for instance, by a user, are proximate to receiving platform 12 and load cells 16, while other locations are remote from receiving platform 12 and load cells 16. The remote positioning and portability features of the control unit 14 facilitate analysis in that a user could easily see and interact with the control unit, regardless of the location and positioning of the weight scale 10a or 10b.

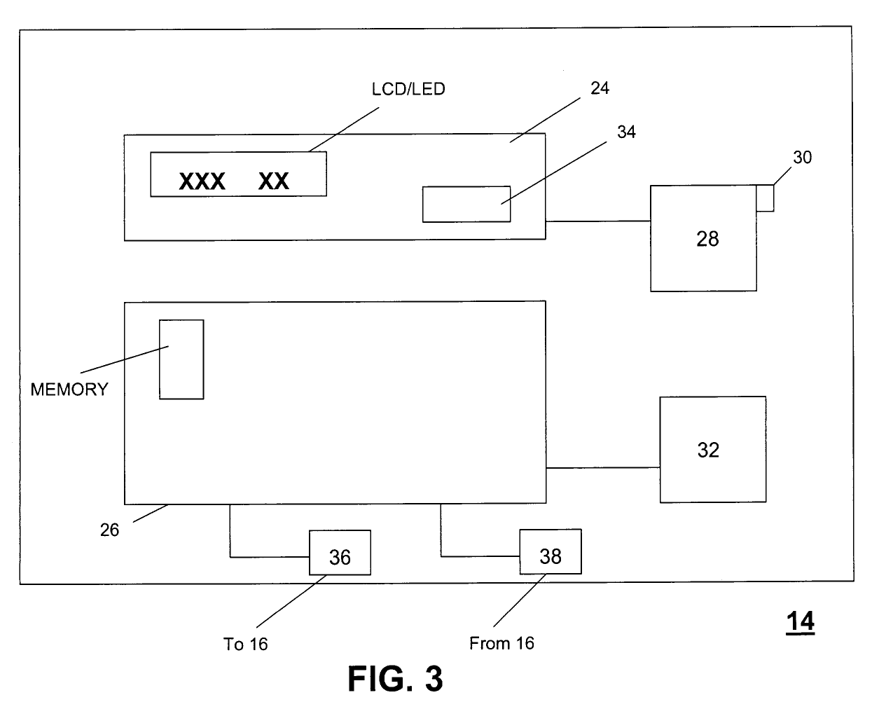

As shown in FIG. 3, control unit 14 includes display 24, processor 26, power source 28, power switch 30 and photo detector 32. Control unit 14 may also include a number of other switches, not shown, each used to control various operations of control unit 14. These other switches includes switches used to initiate calibration, to manually enter a sleep mode, enable automatic entering of the sleep mode, and other functions.

The primary purpose of control unit 14 is to provide a conduit from which to determine the mass of an object placed on receiving platform 12, compare the determined mass to verify the accuracy thereof, and then to display the mass of the object. During the operation of wireless weight scale 10a or 10b, which will be described in more detail below, control unit 14, or more specifically, processor 26 of control unit 14, receives data signals from each of the plurality of load cells 16, calculates the mass of the object placed on receiving platform 12 and transmits signals to display 24, instructing display 24 to display the accurate mass of the object.

Related to the above-stated primary purpose, control unit 14 also controls a number of other tasks and events utilized to effectuate the most-efficient determination of the mass of the object placed on receiving platform 12. For instance, control unit 14 can direct the calibration of each of the plurality of load cells 16. This calibration procedure, which is preferably accomplished via a calibration software process and described in more detail below, eliminates positioning problems in cases in which the object is not located on receiving platform 12 at the exact center. Additionally, the calibration procedure ensures that wireless weight scale 10a or 10b determines the most accurate measurements of the mass of the object placed upon receiving platform 12.

Additionally, control unit 14 is the initiator of the mass determination cycle (as opposed to the individual load cells 16) ; in this way, determination of mass occurs simultaneously, further ensuring the accuracy of the measurement. It is further contemplated that control unit 14 possess the option to select the units of mass measurement, such as, for example, kilograms or other Metric System equivalent, pounds or other English System equivalent, and stones. As discussed above, the majority of these tasks and events are initiated and controlled by processor 26, and are described in detail below.

Preferably, display 24 of control unit 14 contains the various known electronics necessary to convert signals received from processor 26 into a numerical display which is indicative of the mass of the object on receiving platform 12. Additionally, display 24 may also be required to transmit additional information, such as calibration information, that is necessary for the accurate determination of mass. To this end, display 24 may include any known liquid crystal display (LCD) or light emitting diode (LED) capable of displaying up to a five alphanumeric digit number or code (which may include fractional digits, such as, for example, XXX.XX), as well as the electronic equipment necessary to control the LCD/LED and display the alphanumeric number or code upon it, such as, for example, a signal converter. This additional electronic equipment is illustrated on FIG. 3 as signal converter 34. Moreover, instead of a LCD/LED, display 24 may include any alternative, known digital display means.

The processor 26 of control unit 14 preferably includes any known data processing device (and its related electronics) capable of manipulating data in such a manner to arrive at an accurate account of the mass of an object placed on receiving platform 12. Additionally, processor 26 is connected to a wireless transmitter 36 and a wireless receiver 38 of the control unit 14, as shown in FIG. 3. Both processor transmitter 36 and processor receiver 38 are conventional devices used for the purpose of transmitting and receiving wireless signals to and from each of the plurality of load cells 16. Receiver 38 monitors for signals from any of the plurality of load cells 16 when wireless weight scale 10a or 10b is in sleep mode (described below). Preferably, receiver 38 includes any known type of detection apparatus. When wireless weight scale 10a or 10b is in sleep mode, receiver 38 monitors, at predetermined times, to determine if an initial signal (a signal indicating the presence of an object upon receiving platform 12) has been transmitted from any of the plurality of load cells 16.

As illustrated in FIG. 3, control unit 14 also includes power source 28. Preferably, power source 28 is a direct current battery, but it is contemplated that power source 28 may be any other means of delivering the requisite amount of power to control unit 14, including, for example, an alternating current power source, a solar power source, or the like. Preferably, power source 28 also possesses the capability to output the voltage level of power source 28; the purpose for this will be described below with regards to the operation of wireless weight scale 10a or 10b. Additionally, although FIG. 3 illustrates power source 28 as being located outside of display 24 and controlling both display 24 and processor 26, it is contemplated that each of display 24 and processor 26 may possess individual power sources.

Control unit 14 also includes power switch 30. Power switch 30 preferably includes means to turn control unit 14 on and off and to control the transfer of power from power source 28 to both display 24 and processor 26.

Load cells 16 of wireless weight scales 10a and 10b are generally disposed on bottom side 20 of receiving platform 12. Load cells 16 preferably include known types of compression-based measuring devices, such as a strain gauge/foil gauge of resistive type, or a capacitor load cell of capacitive type, capable of determining the mass of an object placed on receiving platform 12. Those skilled in the art should appreciate that, to calculate the mass, load cells 16 preferably include load cell processors, load cell batteries, and other electronics generally situated in a housing.

In some embodiments, the load cells 16 of the wireless weight scale or system each include at least one load cell transmitter and at least one load cell receiver (not shown). Both the load cell transmitter and load cell receiver are in wireless communication with control unit 14, sending and receiving wireless signals such as infrared (IR) signals and radio frequency signals. In other embodiments, wireless communication between the control unit 14 and load cells is provided by satellite transmission, radio broadcasting, cable television broadcasting, direct line-of-site transmission, telecom fiber optic transmission, and cellular transmission. In the above embodiments, because the load cells and control unit both have transmitters and receivers, the scale and system provides for two-way wireless communication. In other embodiments, one or more of the load cells 16 and/or control unit operate under principles of one-way communication. In these embodiments, one or more of the load cells may have either a transmitter or receiver, but not both. Similarly, in some alternative embodiments, the control unit 14 has only a receiver, but not a transmitter.

FIGS. 1A and 1B show embodiments of a wireless weight scale having a single receiving platform 12 on which an object can be placed for weight measurement. One or more load cells 16 are provided on the bottom side 20 of platform 12 to measure and transmit weight information or data using the techniques described above. In alternative embodiments, a wireless weight scale system includes a plurality of platforms 12 with one or more load cells 16 similarly disposed under each of the platforms 12. The load cell under each platform 12 communicates with a control unit which can be located on one of the platforms or at a remote location using techniques described herein. In one example, the wireless weight scale system includes a number of platforms positioned so that each platform receives a wheel of a moving vehicle when the vehicle is moved over the platforms. In this example, the wireless weight scale system uses smaller individual platforms to receive the wheels rather than one larger platform to receive the entire vehicle.

Generally speaking, the mass calculation is preferably done in the following manner: After a mass has been placed on receiving platform 12, and as a result of the introduction of the mass, each of load cells 16 will compress, as a consequence of the forces of gravity upon the mass. The distance of compression of load cells 16 correspond to a particular mass. After receiving an electrical signal corresponding to the distance of compression, load cell processors will determine the mass of the object located on receiving platform 12. This determination may be done through interpolation, in conjunction with a database accessible by load cell processor, or through any other similar means. The load cell outputs a response to the electrical signal, where the response provides weight information regarding the object and is a function of the weight on the load cell. In this configuration, the electrical signal is generated by the control unit, within the load cell, or from some other source. The response is generally output using the wireless transmitter of the load cell.

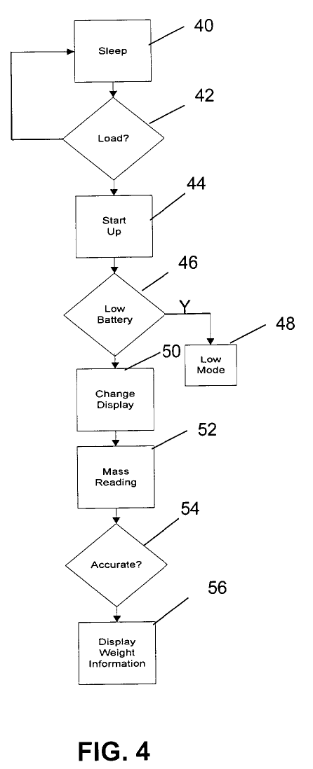

In FIG. 4, after the wireless weight scale has been set up, such as during a first-time battery installation or battery renewal, the system enters into a sleep mode in step 40. The sleep mode, which is essentially similar to a standby mode, allows the system to conserve energy when it is not necessary to expend certain aspects of the system, such as, for example, the LCD display. The system is not off at this time; rather, the system is merely waiting for a load to be placed upon receiving platform 12. Preferably, the system may indicate, by a predetermined code, that the system is currently in sleep mode. Such an indicator may be displayed on LCD of display 24.

In step 42 of FIG. 4, upon the placement of a load upon receiving platform 12, which can occur, for example, when a person steps on receiving platform 12, the system initiates its start-up operations in step 44. In step 46, an electrical signal is sent from processor 26 of control unit 14 to each of the plurality of load cells 16. This signal commands each of the plurality of load cells 16 to determine the status of load cell battery, located within each load cell 16. Preferably, this signal, like all signals transmitted from processor 26 to load cell 16, is sent via IR transmission from processor transmitter, and received by load cell receiver. However, it is contemplated that the transmission of such signals in embodiments of the present invention may be by other wireless means besides IR, such as those listed above.

In step 52 of FIG. 4, preferably the system will attempt to obtain a mass reading within a predetermined period of time, for example, 10 seconds or less. Moreover, the display of the current and/or stable mass reading would be in a preset set of units, such as, for example, kilograms, pounds or stones. The method proceeds to step 54, in which processor 26 ensures that the reading is accurate, that is, stable. When the reading is stable, a signal is transmitted from processor 26 of control unit 14 to display 24 to display the determined value of the mass of the load on receiving platform 12, in step 56. A signal is then transmitted from processor 26 to display 24 to indicate that the load is to be removed from receiving platform 12. The display on LCD may remain illuminated for a predetermined period of time after the load has been removed from receiving platform 12.

After the load has been taken off receiving platform 12, and a signal has been transmitted from each of the plurality of load cells 16 to processor 26 confirming this, processor 26 will transmit a signal to display 24 to shut off the LCD. After the LCD has been shut off, the system will attempt to obtain a second stable zero reading for the upcoming measurement. Once the second stable zero reading has been obtained, processor 26 will compare the second stable zero reading with the first stable zero reading. If the second stable zero reading differs from the first stable zero reading by more than one kilogram/two pounds, an indication signal is transmitted from processor 26 to display 24 to indicate that the load should be placed on receiving platform 12 again for a second measurement. When the load is indeed placed on receiving platform 12, in step 42, the process for measuring mass, described above, is repeated.

If the second stable zero reading does not differ from the first stable zero reading by a predetermined limit, for example, one display step, an indication signal is transmitted from processor 26 to display 24 to indicate that the reading, previously displayed, is accurate. Preferably, again, this indication will be displayed for a predetermined period of time in step 56. At this point, a termination signal is transmitted from processor 26 to display 24 to turn the LCD off. After a predetermined period of time, the system reenters sleep mode in step 40.

When an event has timed out, which could happen for example if a requested action does not occur within a predetermined period of time, a signal would be transmitted from processor 26 to display 24, instructing display 24 to display a predetermined error message for a predetermined period of time, after which the system would reenter sleep mode in step 40. Moreover, a predetermined error signal may also be instructed to be displayed if receiving platform 12 is either over-weighted or under-weighted.

Additionally, embodiments of the system of the present invention possess a Calibration Mode. The Calibration Mode is used to ensure the accurate readings of object mass performed by the system. To enter the Calibration Mode, a calibration switch (which may be a push button switch, a foot switch, a toggle switch, or other switch) coupled to the control unit 14 is activated, initiating the calibration procedures. Upon the activation of the calibration switch, processor 26 of control unit 14 will transmit a “Calibration Mode” command signal, through the control unit transmitter, to each of the plurality of load cells 16, where the signal is received by the load cell receivers. The “Calibration Mode” command signal instructs each of the plurality of load cells 16 to switch from the normal operation mode to a calibration mode. Upon receipt of the “Calibration Mode” command signal, each of the plurality of load cells 16, through load cell transmitter, will transmit a “Calibration Acknowledgement” return signal back to the receiver of control unit 14. Then, one by one, the system, through processor 26, will perform a calibration check on each of the following aspects: the LCD, the zero offset of each of the load cells 16, the compensation factor of each of the load cells 16 and the amplification.

To calibrate the LCD, upon the system's entry into Calibration Mode, a signal will be transmitted from processor 26 to display 24, instructing display 24 to turn on each of the pixels contained in the LCD for a predetermined period of time. Doing so ensures that the LCD is property connected, that there are no short circuits, that each of the pixels is in proper working order and that there are no problems with the LCD.

To calibrate the zero offset of each of the plurality of load cells 16, a signal will be transmitted from processor 26 to one of the plurality of load cells 16. This signal instructs the load cell 16 to record and continuously transmit, back to processor 26, the analog/digital (A/D) count value. This count value is a digital representation of the weight information or reading. If the count value is within an acceptable range of values (the acceptable range of values being stored within a memory location accessible by processor 26), a signal will be sent from processor 26 to display 24, instructing display 24 to display the count value. If the count value is not within the acceptable range of values, a signal will be sent from processor 26 to display 24, instructing display 24 to display the characters “HHHH” or “LLLL,” depending on whether the received count value is higher or lower than the acceptable range of values. Signals will then be sent from processor 26 to the load cell 16, directing the load cell 16 to set the A/D count value. After the count value has been adjusted, a signal will be sent from processor 26 to display 24 indicating the same. At this point, the system will stand by and prompt the user to toggle the switch entering Calibration Mode; when the switch has been toggled, the system will go on to calibrate the zero offset of the next load cell 16. When all zero offsets of each load cell 16 have been calibrated, the system then proceeds to the next calibration steps.

To calibrate the compensation factor of each of the load cells 16, processor 26 of control unit 14 first records the A/D count value of the first load cell 16. An object of known mass will then be placed upon receiving platform 12 and the switch is depressed. The calibration of the A/D count value, as described above, for the load cell 16 will be performed under load. Next, the A/D count value of a additional load cells 16 will be recorded. Upon the completion of all load cells 16, processor 26 will calculate the A/D count change of each load cell 16 (under load vis a vis under no load), and the minimum A/D count change among the individual load cells 16. After these values have been calculated, processor 26 will calculate the compensation value according to the following formula:

F(n)=dC(n)/dC(min)

where n=the subject load cell, dC(n) is the A/D count change by loading the subject cell and dC(min) is the minimum A/D count change among the load cells.

Finally, the system will calibrate the amplification. Initially, processor 26 will obtain a stable zero reading. Preferably, this occurs in the same manner as described above. After a stable zero reading has been obtained, an object of a known mass is placed on receiving platform 12. Preferably, the mass of this object is also known by processor 26. Processor 26 then proceeds to determine the value of the mass of the object. If the value of the mass of the object is equal to the known value of the mass of the object, a signal is transmitted from processor 26 to display 24, instructing display 24 to display the value of the mass of the object. On the other hand, if the value of the mass of the object is not equal to the known value of the mass of the object, a signal is transmitted from processor 26 to display 24, instructing display 24 to display the characters “HHHH” or “LLLL,” depending on whether the value of the mass of the object is higher or lower than the known value of the mass of the object. At this point, the system will perform the steps, described above, with reference to the zero offset and/or compensation factor until the value of the mass of the object is equal to the known value of the mass of the object. This process is repeated with a second object, also of known mass.

In FIGS. 1A and 1B, the control unit 14 or 23 preferably includes one or mode input channels which can receive wireless signals sent by the load cells. In one embodiment, these inputs carry the received signals through an A/D conversion unit within the control unit to interpret and decipher the received signals. In this embodiment, the input channels are also referred to herein as “A/D channels.” Weight information is gathered from the signals after passing through the A/D channels, so the control unit can determine the mass or weight of the object on the wireless weight scale 10a or 10b. In an alternate embodiment, the control unit provides no A/D function; instead, the respective load cells have A/D converters to perform the A/D conversion, such that weight data is acquired at the load cells before being transmitted to the control unit as a wireless signal.

As explained above, wireless weight scales constructed according to embodiments of the present invention can have a number of configurations. Various numbers of load cells can be used, and the control unit can be located at various positions with respect to the weight scale. Due to the number of configurations possible, it is desirable to store settings associated with respective configurations in a memory that is connected to or forms a part of the control unit. In one embodiment, this memory includes an EEPROM which stores the configuration settings.

The start-up procedure referred to in FIG. 4, step 44, can be initiated in various ways. In one embodiment, the start-up procedure is initiated by pressing of a flip switch connected to the control unit or load cells. After the battery is installed, the control unit and load cells will begin polling for an initial weight signal from the scale. In another embodiment, when the start-up procedure is performed by the control unit, the control unit transmits an initialization signal to the load cell when the flip switch is activated. In yet another embodiment, when the start-up procedure is performed by the load cells, the load cells transmit the initialization signal to the control unit when the flip switch is pressed. After the control unit receives this initialization signal, the control unit transmits a second initialization signal to all of the load cells to ensure that all of the load cells have been notified.

When the various units, including the control unit and the load cells, are activated, the units enter one of the operation modes described above, and begin checking the batteries as described above. If one of the load cells has a low battery, the control unit will regard the start-up procedure as a failure. In one embodiment, the control unit will then initiate the start-up procedure again. If the start-up procedure fails for three consecutive attempts, the control unit will display an error message for a predetermined amount of time, 1 second in one example, and then proceed to sleep mode.

The wireless weight scale described above performs weight measurements preferably using a voltage to frequency A/D circuit. The control unit is capable of receiving an internal count, which represents the voltage output of the load cell from an A/D frequency output. For each data acquisition cycle, which includes weight measurement and stable zero readings, the control unit will command the load cells to start recording the A/D output simultaneously. After that, the control unit will poll each load cell for the binary A/D result and normalize the data by a compensation factor, which has been detected during calibration mode. Finally, compensated data from each A/D channel will be added together and displayed according to the resolution setting.

In one example, the control unit and the load cells each have transmitting and receiving ports for two-way communication. For the transmitting port, the control unit is able to generate a code pulse with a carrier frequency such as 38 kHz to drive an IR diode. For the receiving port, the IR signal generated by the IR diode is received by an IR receiver and fed to the receiving port for decoding. In order to share this IR channel without errors, the control unit initiates communication among the various units except during the start-up procedure. Data can be transferred in serial order in a binary format during communication.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. For example, while one embodiment of the present invention presented herein relates to a personal weight scale, embodiments of the present invention may be incorporated in other situations such as commercial applications involving the weighing of objects for trade purposes. All such modifications and variations are intended to be included herein within the scope of the invention and protected by the following claims.

What is claimed is:

1. A wireless weight scale comprising:
a receiving platform, the receiving platform including a top side and a bottom side, the receiving platform being able to receive a load, the load having a mass;
a load cell disposed on the bottom side of the receiving platform, the load cell including a load cell wireless transmitter; and
a control unit including a display and a processor connected to a wireless transmitter and a wireless receiver;
wherein the load cell wireless transmitter transmits a wireless signal to the wireless receiver upon the detection, by the load cell, of the load upon the receiving platform.

2. The wireless weight scale of claim 1, further comprising:
a second load cell disposed on the bottom side of the receiving platform, the second load cell including a second load cell wireless transmitter.

3. The wireless weight scale of claim 1, wherein the receiving platform is composed of a substantially transparent material.

4. The wireless weight scale of claim 1, wherein the control unit further includes a power source, a power switch and a photo detector.

5. The wireless weight scale of claim 1, wherein the processor includes a memory location.

6. The wireless weight scale of claim 1, wherein the load cell further includes a power source.

7. The wireless weight scale of claim 1, wherein the wireless signal includes an infrared signal.

8. The wireless weight scale of claim 1, wherein the wireless signal includes a radio frequency signal.

9. The wireless weight scale of claim 1, wherein the wireless weight scale operates in at least two operational modes.

10. A wireless weight scale comprising:
a plurality of receiving platforms, the receiving platforms each including a top side and a bottom side, the receiving platforms being able to receive a load, the load having a mass;
a plurality of load cells each disposed on the bottom side of a respective receiving platform, each load cell including a load cell wireless transmitter and a load cell wireless receiver; and
a control unit including a display and a processor connected to a wireless transmitter and a wireless receiver;
wherein each of the load cell wireless transmitters is capable of transmitting a wireless signal to the wireless receiver upon the detection, by the load cell, of the load upon the respective receiving platform.

11. The wireless weight scale of claim 10, wherein each of the plurality of load cells further includes a power source.

12. A wireless weight scale comprising:
a receiving platform, the receiving platform including a top side and a bottom side, the receiving platform being able to receive a load, the load having a mass;
a first load cell disposed on the bottom side of the receiving platform;
a second load cell disposed on the bottom side of the receiving platform, the second load cell including a second load cell wireless transmitter; and
a control unit connected to the first load cell, the control unit including a display and a processor connected to a wireless receiver;
wherein the first load cell sends a signal to the control unit upon the detection, by the first load cell, of the load upon the receiving platform, and
wherein the second load cell wireless transmitter transmits a wireless signal to the wireless receiver of the control unit upon the detection, by the second load cell, of the load upon the receiving platform.

13. A system for determining the mass of an object, comprising:
receiving means for receiving the object;
initiation means for initiating a mass-determining cycle;
measuring means for measuring an initial mass value;
wireless transmission means for transmitting the initial mass value over a wireless network;
calculation means for calculating a final mass value; and
display means for displaying the final weight value.

14. The system of claim 13, wherein the wireless transmission means includes an infrared signal.

15. The system of claim 13, wherein the wireless transmission means includes a radio frequency signal.

16. A system for weighing an object, the system comprising:
a wireless weight scale including:
a receiving platform, the receiving platform including a top side and a bottom side, the receiving platform being able to receive a load, the load having a mass, and
a plurality of load cells, each of the plurality of load cells being disposed on the bottom side of the receiving platform, each of the plurality of load cells including at least one load cell wireless transmitter and a load cell wireless receiver; and
a control unit, including a display and a processor connected to a wireless transmitter and a wireless receiver;
wherein one of the load cell wireless transmitters transmits a wireless signal to the wireless receiver of the control unit upon the detection, by the load cell, of the load upon the receiving platform.

17. The system of claim 16, wherein the control unit is remotely located from the wireless weight scale.

18. The system of claim 16, wherein the control unit is portable.

19. The system of claim 16, wherein the control unit is situated on a table.

20. The system of claim 16, wherein the control unit is mounted to a wall.

21. The system of claim 16, wherein the control unit is connected to a workstation.

22. The system of claim 16, wherein the wireless signal includes an infrared signal.

23. The system of claim 16, wherein the wireless signal includes a radio frequency signal.

24. A method for determining the mass of an object using a wireless weight scale, the wireless weight scale including a receiving platform, a control unit and a load cell, the method comprising:
transmitting a signal to initiate a mass-determining cycle;
calculating a first mass value in the load cell of the wireless weight scale, responsive to the receiving platform receiving the object, the first mass value corresponding to a force applied by the mass on the load cell;
receiving a wireless signal corresponding to the first mass value from a wireless transmitter of the load cell;
calculating, based on the first mass value, the mass of the object; and
displaying the calculated mass.

25. The method of claim 24, further comprising:
determining a stable reading for the first mass value, the stable reading based on a plurality of consecutive calculations of the first mass value within a predetermined range, wherein:
the calculated mass is displayed when the stable reading is determined.

26. The method of claim 24, further comprising:
determining whether a battery, disposed within the wireless weight scale, has a voltage at or above a predetermined threshold; and
initiating a low battery mode of operation when the battery voltage is below the predetermined threshold.

27. The method of claim 24, wherein the wireless weight scale enters a sleep mode when not in use for a predetermined period of time.

28. The method of claim 27, wherein a photo detector activates the wireless weight scale from sleep mode when the object is received on the receiving platform.

29. The method of claim 24, further comprising calibrating the wireless weight scale prior to the transmission of the signal to initiate the mass-determining cycle.
